(19) United States
(12) Patent Application Publication
(10) Pub. No.: US 2014/0068980 A1
(43) Pub. Date: Mar. 13, 2014

(54) Contoured Display Device

(71) Applicant: Adam Melendez, South El Monte, CA (US)

(72) Inventor: Adam Melendez, South El Monte, CA (US)

(21) Appl. No.: 13/606,592

(22) Filed: Sep. 7, 2012

(51) Int. Cl. G09F 19/00; G09F 13/00

(52) U.S. Cl. 40/540; 40/538

(57) ABSTRACT

A novel display device is disclosed that comprises an inflatable bladder and a cover attachable to the bladder designed to create and maintain a three-dimensional effect. The bladder may be continuously inflatable or air tight. The bladder has a contour shaped into a silhouette of a person, place, or thing. The cover has an image thereon that is complementary to the silhouette of a person, place, or thing. Breather ports may be disposed about the cover to permit air escaping the bladder to inflate the cover without overinflation. The portable and lightweight displays may include a means for attaching the displays to walls or buildings or on top of a promotional tent. The disclosed embodiments may also include lighting to further the eye-catching appeal and three-dimensional effect.

### BACKGROUND

The present disclosure generally relates to advertising devices and more particularly to eye-appealing, three-dimensional displays.

The advertising industry is replete with billboards or displays of varying kinds designed to attract the attention of the market place. Conventional outdoor advertising typically consists of a rectangular billboard that is expensive to construct, heavy, and permanently affixed. Inflatable displays have been used where lighter weight and portability is desired. However, conventional inflatable displays are prone to deflating and difficult to keep upright particularly involving large-scale installations. Moreover, conventional inflatable displays are also generally rectangular in shape and uninteresting regardless of size.

Accordingly, a lightweight, portable, attention-grabbing, and inexpensive display device that creates and maintains a three-dimensional effect is therefore desired.

### SUMMARY

One exemplary embodiment of the disclosed subject matter is a display device comprising an inflatable bladder and a cover attachable to the bladder designed to create and maintain a three-dimensional effect. The bladder may be continuously inflatable or air tight. The bladder has a contour shaped into a silhouette of a person, place, or thing. The cover has an image thereon that is complementary to the silhouette of a person, place, or thing.

In one aspect of the disclosed embodiments, breather ports are preferably disposed about the cover to permit air escaping the bladder to inflate the cover without overinflation. The ratio of breather ports surface area to cover surface area is preferably about 0.13% to 0.23%. If the ratio were different, the cover may overinflate or become loose or otherwise show the bladder underneath.

In another aspect of the disclosed embodiments employing a continuously inflatable bladder, the bladder may be formed of fabric walls or panels and baffles attached together to form the desired shape of the silhouette. The baffles preferably have holes to allow air to disperse throughout the bladder to help maintain the shape and overall appearance of the contoured display.

In yet another aspect of the disclosed embodiments employing a continuously inflatable bladder, the bladder may be formed of ropes or webbing attached together to form the desired shape of the silhouette. The ropes or webbing allow incoming air to fill the bladder continuously and evenly while maintaining the display's shape.

The portable and lightweight displays of the disclosed embodiments may advantageously include a means for attaching the displays to walls or buildings. The disclosed embodiments may also include lighting to further the eye-catching appeal and three-dimensional effect.

### BRIEF DESCRIPTION OF THE DRAWINGS

Some non-limiting exemplary embodiments of the disclosed subject matter are illustrated in the following drawings. Identical or duplicate or equivalent or similar structures, elements, or parts that appear in one or more drawings are generally labeled with the same reference numeral, optionally with an additional letter or letters to distinguish between similar objects or variants of objects, and may not be repeatedly labeled and/or described. Dimensions of components and features shown in the figures are chosen for convenience or clarity of presentation. For convenience or clarity, some elements or structures are not shown or shown only partially and/or with different perspective or from different point of views.

FIG. 1 is a perspective view of an embodiment of the inventions disclosed herein with portions cut away;

FIG. 2 illustrates a top view of the embodiment illustrated in FIG. 1 with the cover removed and portions cut away;

FIG. 3 illustrates a top view of the embodiment illustrated in FIG. 1 with the cover removed and portions cut away;

FIG. 4 illustrates a front view of the embodiment illustrated in FIG. 1 with the cover removed;

FIG. 5 illustrates a back view of the embodiment illustrated in FIG. 1 with the cover removed;

FIG. 6 illustrates a perspective view of another embodiment of the inventions disclosed herein with optional truss;

FIG. 6A illustrates a perspective view of another embodiment of the inventions disclosed herein with optional truss and support tubing;

FIG. 7 illustrates a perspective view of another embodiment of the inventions disclosed herein with portions cut away;

FIG. 8 illustrates a side view of another embodiment of the inventions disclosed herein with the cover removed;

FIG. 9 illustrates a perspective view of the bladder embodiment illustrated in FIG. 8;

FIG. 10 illustrates a side view of another embodiment of the inventions disclosed herein with the cover removed; and

FIG. 11 illustrates a perspective view of the bladder embodiment illustrated in FIG. 10.

### DETAILED DESCRIPTION

A general problem in the field of advertising is billboards or displays that are heavy, expensive, and permanently affixed to a building or structure. A general solution is an advertising unit that is lightweight, portable, and relatively inexpensive to construct.

A technical problem in the field of advertising is rectangular, one-dimensional billboards or displays that are mundane and generally uninspiring. A technical solution in the field of advertising is a contoured display designed to create and maintain a three-dimensional effect and thereby attract the attention and interest of a passerby.

Potential benefits of the general and technical solutions provided by the disclosed subject matter include those identified above, as well as an extremely large and eye-catching display that may be placed on top of a building or easily mounted to a wall.

A general nonlimiting overview of practicing the present disclosure is presented below. The overview outlines exemplary practice of embodiments of the present disclosure, providing a constructive basis for variant and/or alternative and/or divergent embodiments, some of which are subsequently described.

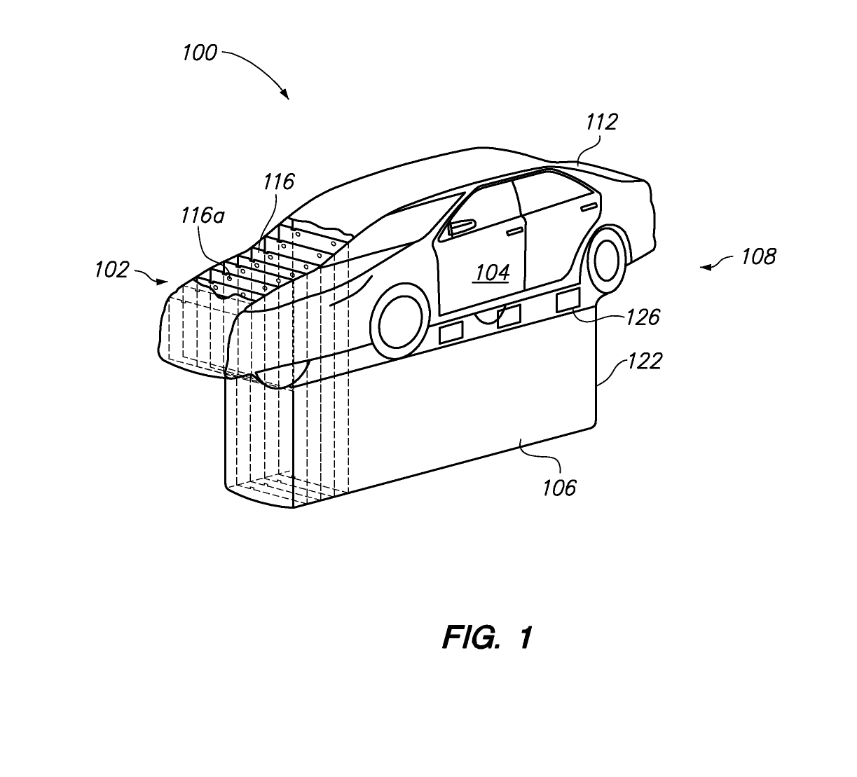

FIG. 1 is a perspective view of an embodiment of the inventions disclosed herein. As seen in FIG. 1, a display device 100 may comprise a bladder 102 configured to be inflated while also being deflated, wherein the bladder 102 has a contour shaped into a silhouette of a person, place, or thing. A cover 104 is attachable to the bladder 102, wherein the cover 104 has an image complementary to the silhouette of a person, place, or thing. For example, the bladder 102 shown in FIG. 1 is contoured to the shape of a car and the cover 104 has the appropriate corresponding image thereon. As further illustrated in FIG. 1, the bladder 102 may include a base 106 that gives an appearance that the car is seated on a platform or pedestal to further the three-dimensional effect and eye-appealing aspects of the disclosed inventions.

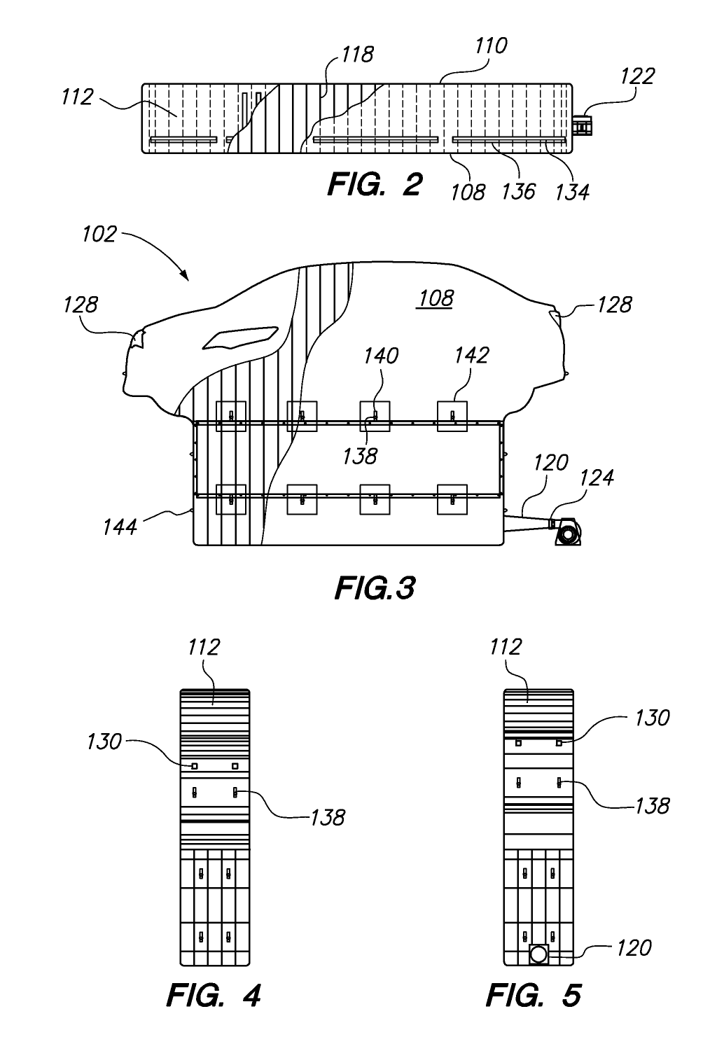

FIGS. 2 through 5 illustrate views of the display 100 illustrated in FIG. 1 with the cover 104 removed for a better understanding of the interior of the device 100. These figures as well as FIG. 1 illustrate that the bladder 102 may comprise a front wall 108 and a back wall 110 joined to a plurality of baffles 116. The baffles 116 preferably have holes 116a therein to allow incoming air to flow evenly through the bladder 102. Air is received in the bladder 102 via duct 120, which is in communication with a blower 124 coupled to the duct via buckle 120. The baffles 116 are preferably made of fabric or 200D nylon, whereas the walls 108, 110 are preferably made out of coated fabric or 400D nylon to prevent air from escaping. The walls 108, 110 are preferably sewn to the baffles 116 along baffles lines 118. The contoured panel 112 is preferably made of 8-ounce vinyl.

Looking at the top of the device 100 with cover 104 removed, FIG. 2 illustrates that there are attachment means for attaching the cover 104 to the bladder 102. Such means may include sewing, hook and loop, grommets, adhesive, or the like. FIG. 2 illustrates the attachment means is hook and loop as shown by component 136. Proximate hook and loop component 136 are ¾″ zippers 134 used for rapid deflation of the device.

Turning in detail to FIGS. 3 through 5, bladder 102 may have one or more transparent sections 128 to permit a lighting element (not shown) to be joined by hook and loop 130 or the like for illuminating each section 128. When lit, each section lights a respective section of the cover 104 to simulate the lighting of the headlights and/or taillights of a car, such as that illustrated in FIG. 1, to further enhance the three-dimensional and eye-appealing effect of display 100.

Bladder 102 may also have a plurality of tethering equipment, such as 2″ D-rings 138, for securing the display 100 to the ground or mounting the device to a wall or building. As the D-rings 138 will induce a greater localized load on the bladder 102, the bladder is preferably made to have greater structural integrity for the rings 138 by way of 2″ reinforcement webbing 140 and reinforcement panels 142 made of 18-ounce vinyl.

FIG. 3 also illustrates grommets 144 or the like may be used to attach an advertising banner or the like to the optional base 106.

The cover 104 is preferably a coated fabric, which is not breathable, that has the corresponding image made thereon by way of digitally printed ink or paint. As an alternative to coated fabric, the cover 104 may be made of a porous or breathable material such as polyester or Lycra. However, as both polyester and Lycra materials do not have good UV resistance, these materials should be reserved for indoor application only.

Turning again to FIG. 1, one or more breather ports 126 are preferably disposed about the cover 104. Breather ports 126 are preferably made of a mesh material. The number of breather ports 126 depends on the size of the display 100. Finding the right balance of air between the printed cover 104 and bladder 102 is preferable. For example, too few breather ports 126 may cause the digitally printed cover 104 to overinflate. In contrast, too many breather ports 126 may cause the digitally printed cover 104 to become loose and the bladder 102 may show through the cover 104.

In operation, air is constantly driven by the blower 122 through the air duct 120 into the bladder 102, passing through holes 116a in baffles 116 along the way. At the stitched union points along baffle lines 118, air minimally escapes at each stitched point. When the digitally printed cover is placed over the bladder 102 with air constantly running therethrough, the air permeating through the stitches causes the cover 104 to expand in a convex or bulbous manner. However, when the disclosed breather ports 126 are added, such ports 126 allow the cover 104 to inflate just enough to prevent overinflation. The number and configuration of breather ports may need to be modified to find the right balance.

The breather ports 126 used by one or more of the embodiments disclosed herein typically come in sizes from 2″ by 4″; 2″ by 6″; 2″ by 8″; or 2″ by 10″. A 20′ by 30′ inflatable device 100 may use six evenly spaced breather ports (measuring 2″ by 10″). A 10′ by 15′ inflatable device 100 may use four evenly spaced breather ports (measuring 2″ by 6″). In light of this information, the ratio of breather ports 126 surface area to cover 104 surface area is preferably about 0.13% to 0.23%.

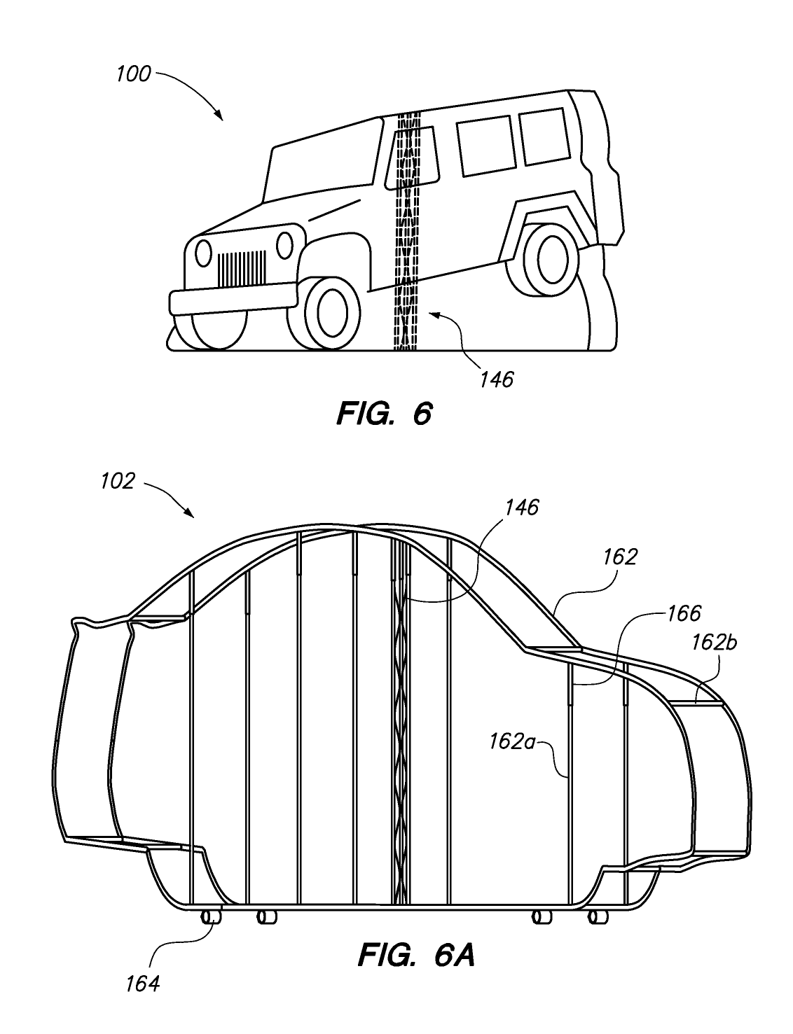

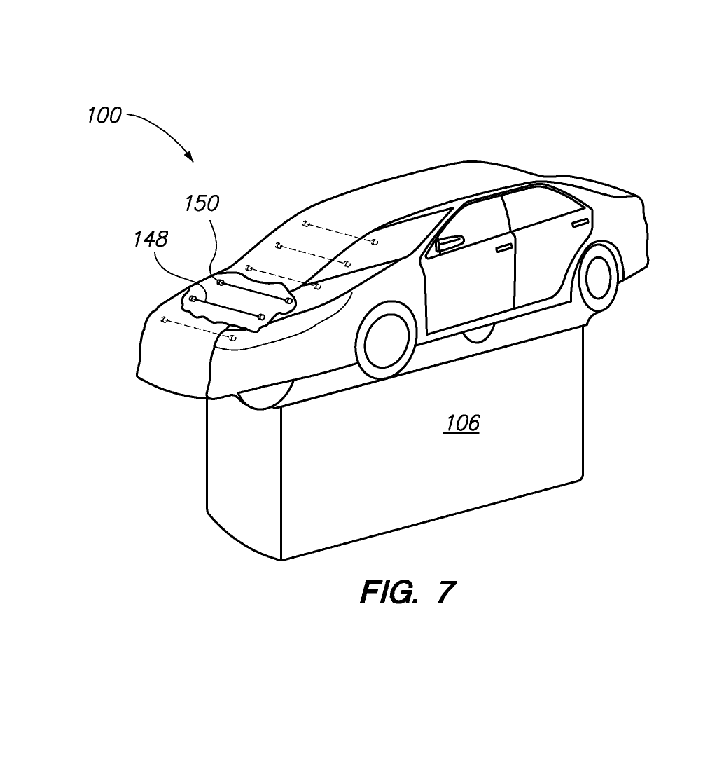

FIG. 6 illustrates a perspective view of another embodiment of the inventions disclosed herein with optional truss 146. Such a truss 146 may optionally be disposed within or about the display 100 for additional support. Similar to FIG. 6, FIG. 6A illustrates a perspective view of another embodiment of the inventions disclosed herein with optional truss 146 and/or support tubing 162, 162a, 162b. Such tubing 162, 162a, 162b may be used to refine the contours of a display having sharp curves or cuts by better stretching the cover (not shown) over the bladder 102. Tubing 162 is preferably made of 1″ square, steel tubing. Tubing 162a is preferably made of ¾″ round, plastic tubing. Connectors 166, which are preferably made of ⅞″ round, plastic tubing, are used to connect the tubing 162, 162a, or 162b together. Hinges 164 are disposed on or about tubing 162 for ease of opening the perimeter frame created by tubing 162. As illustrated in FIG. 6A, truss system 146 may include two 3/16″ wires.

FIG. 7 illustrates a perspective view of another embodiment of the inventions disclosed herein with portions cut away. In particular, FIG. 7 illustrates an alternative structure to the fabric baffles 116 shown in FIGS. 1 through 5. Such structure may be a plurality of ropes 148 preferably from ⅛″ to ¼″, normally double-braided or a standard rope that has a minimum of 500 pounds of breaking strength. Instead of ropes 148, one may also use flat nylon or polyester binding tape or webbing that is ¼″ or up to 1″ wide. Such ropes 148 or webbing may be placed consistently every 8″ to 12″, as illustrated in FIG. 7. The ropes 148 may be joined to walls 108, 110 by way of snap links 150, standard rope knots, simply stitched (webbing only), or the like to help prevent overexpansion.

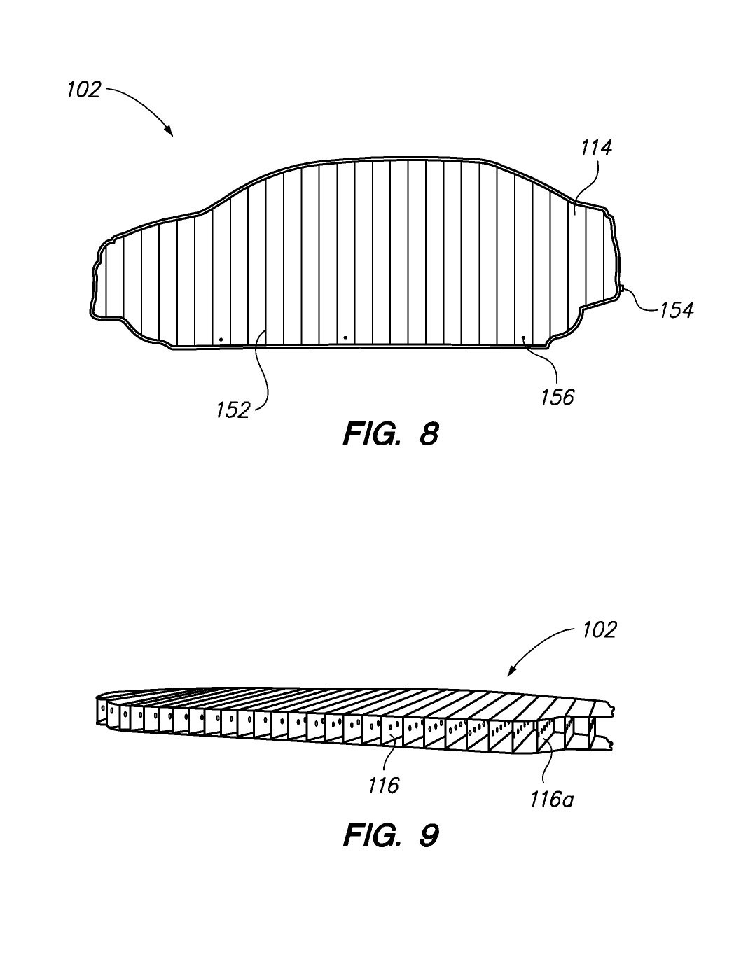

Turning to FIGS. 8 through 11, another embodiment of the inventions disclosed herein includes a contoured display device 100 that creates a three-dimensional effect comprising an air tight bladder 102 adapted to be inflated wherein the bladder 102 has a contour shaped into a silhouette of a person, place, or thing. The device 100 further includes a cover 104 (not shown) attachable to the bladder 102 and having an image complementary to the silhouette of a person, place, or thing. The device 100 may be comprised of one or more coated fabric walls or panels 114 joined to baffles 116 with holes 116a, as illustrated in FIGS. 8 through 9. The panels 114 may be hot air welded or heat sealed together using coated fabrics to prevent air from escaping. One or more air valves 154 may be used to inflate the air tight inflatable device 100 by way of an inflation blower (not shown) or the like. Deflation may be done through one or more valves, such as valve 156 illustrated in FIG. 8. Such an inflatable device 100 may maintain its shape and rigidity with less than 1 PSI or more.

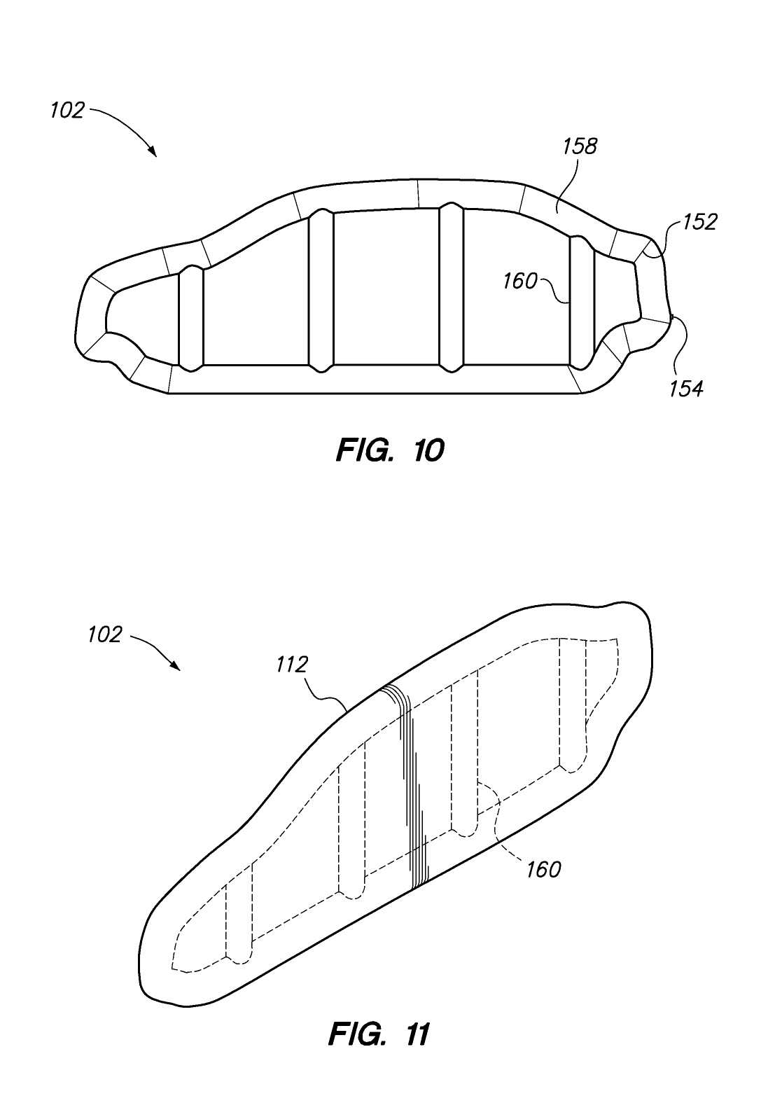

Turning to FIGS. 10 through 11, instead of fabric panels 114 and baffles 116, the bladder 102 may comprise a plurality of tubing sections 158 joined together by way of heat seals 152. Inflatable supports 160 may be internal to the bladder 102, wherein the supports 160 are configured to support the contour of the bladder 102.

As with the device 100 illustrated in FIGS. 1 through 7, the bladder 102 in FIGS. 8 through 11 may include one or more transparent sections (not shown), and further comprise lighting (not shown) disposed about each transparent section. The device 100 may similarly include a means for mounting (not shown) the device to a wall or building. Moreover, a truss (not shown) may optionally be disposed within or about the device for supporting the device.

The exemplary embodiments illustrated in FIGS. 1 through 11 advantageously create a three-dimensional effect with a flat surface and contoured perimeter. Such embodiments also advantageously permit display devices that may range from 8′ to 100′ in height or length. Moreover, due to the light weight of the disclosed inventions, such displays 100 may be mounted not only to a wall, including a vertical wall of a building, but also placed on top of a tent to provide a message or advertisement. The tent may be made into any configuration just enough to support the length, width, and height of the display device 100 in a manner similar to base 106 illustrated in FIG. 1.

While certain embodiments have been described, the embodiments have been presented by way of example only and are not intended to limit the scope of the inventions. Indeed, the novel devices and methods described herein may be embodied in a variety of other forms; furthermore, various omissions, substitutions, and changes in the form of the devices and methods described herein may be made without departing from the spirit of the inventions. The accompanying claims and their equivalents are intended to cover such forms or modifications as would fall within the scope and spirit of the inventions.

1. A display device comprising:
a bladder configured to be inflated while also being deflated, wherein the bladder has a contour shaped into a silhouette of a person, place, or thing; and
a cover attachable to the bladder, wherein the cover has an a pre-existing image complementary to the silhouette of a person, place, or thing.

2. The device according to claim 1 further comprising one or more breather ports formed in the cover.

3. The device according to claim 2 wherein the ratio of breather ports surface area to cover surface area is about 0.13% to 0.23%.

4. The device according to claim 1 further comprising baffles disposed within the bladder.

5. The device according to claim 4 wherein the baffles are made of fabric walls having holes.

6. The device according to claim 4 wherein the baffles are made of ropes.

7. The device according to claim 1 further comprising an air duct in communication with the bladder and a blower in communication with the air duct for allowing the bladder to be continuously inflated.

8. The device according to claim 1 wherein the bladder is comprised of a plurality of panels stitched together to form the silhouette, whereby the bladder may be continuously deflated.

9. The device according to claim 1 wherein the cover comprises digitally printed fabric.

10. The device according to claim 1 wherein the bladder includes one or more transparent sections, and further comprising lighting disposed about each transparent section.

11. The device according to claim 1 further comprising means for mounting the device to a wall or building.

12. A contoured display device that creates a three-dimensional effect comprising:
an air tight bladder adapted to be inflated wherein the bladder has a contour shaped into a silhouette of a person, place, or thing; and
a cover attachable to the bladder and having an a pre-existing image complementary to the silhouette of a person, place, or thing.

13. The device according to claim 12 wherein the bladder comprises a plurality of tubing.

14. The device according to claim 13 further comprising inflatable supports internal to the bladder, wherein the supports are configured to support the contour of the bladder.

15. The device according to claim 12 further comprising baffles adapted to fit within the bladder.

16. The device according to claim 15 wherein the baffles are made of fabric walls having holes disposed therein.

17. The device according to claim 12 wherein the bladder comprises a plurality of sections heat sealed together.

18. The device according to claim 12 wherein the bladder includes one or more transparent sections, and further comprising lighting disposed about each transparent section.

19. The device according to claim 12 further comprising means for mounting the device to a wall or building.

20. The device according to claim 12 further comprising a truss disposed within or about the device for supporting the device.
